(19) United States
(12) Patent Application Publication
(10) Pub. No.: US 2019/0386840 A1
(43) Pub. Date: Dec. 19, 2019

(54) COLLABORATION SYSTEMS WITH AUTOMATIC COMMAND IMPLEMENTATION CAPABILITIES

(71) Applicant: Cisco Technology, Inc., San Jose, CA (US)

(72) Inventors: Keith Griffin, Co. Galway (IE); John Knight Restrick, JR., Montclair, NJ (US)

(21) Appl. No.: 16/011,221

(22) Filed: Jun. 18, 2018

(51) Int. Cl. H04L 12/18; G06Q 10/10

(52) U.S. Cl. CPC H04L 12/1822; G06Q 10/10; H04L 12/1818; H04L 12/1831

(57) ABSTRACT

Methods, systems and computer-readable medium are provided for implementing commands by a collaboration system on behalf of participants of an event utilizing such collaboration system. A method includes identifying participants associated with an event conducted using an online collaboration system; generating a per-participant metric for each one of the participants to generate a plurality of metrics; populating each of the plurality of metrics for a corresponding participant using data received from multiple data sources, each data source providing a particular type of data for the corresponding participant and in association with participation of the corresponding participant in the event; determining a command to be performed on behalf of one or more of the participants; determining, using the plurality of metrics, at least one target associated with the command to yield at least one identified target; and performing the command for the at least one target.

### TECHNICAL FIELD

The present disclosure pertains to collaboration systems and more specifically to collaboration systems capable of automatically implementing commands corresponding to an event utilizing such collaboration systems.

### BACKGROUND

Collaboration systems are increasingly being used to allow multi-party conferencing and conducting of events that allow many participants to participate from different geographical locations. For example, participants from multiple geographic locations can join a conference meeting and communicate with each other to discuss issues, share ideas, etc.

Such collaboration systems continuously evolve and are upgraded to utilize various techniques that help simplify administrating the event. For example, sensors, voice and face recognition techniques are used to implement functions such as zooming camera(s) on a speaking participant, enable collaboration between the system and the participants upon receiving audio instructions from one or more participants, etc. However, these collaboration systems still suffer from a deficiency of automatic implementation of commands/requests on behalf of participants. For example, in a given event in which several individuals participate from the same physical/virtual location/space, when one participant direct the system to perform an action on behalf to the participant (e.g., “start my meeting”), the system is not enable to deduce which participant the term “my” refers to in order to perform the function on behalf of that participant. Accordingly, there is room to address existing problems and further improve such collaboration systems.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates an event setting, according to one aspect of the present disclosure;

FIG. 2 is a method of automatic implementation of cognitive actions, according to one aspect of the present disclosure;

FIG. 3A is an example per-user metric, according to one aspect of the present disclosure;

FIG. 3B is an example collection of per-user metrics, according to one aspect of the present disclosure;

FIG. 4A is an example system, according to one aspect of the present disclosure; and

FIG. 4B is an example system, according to one aspect of the present disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

References to one or an embodiment in the present disclosure can be, but not necessarily are, references to the same embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program services or functional processes include routines, programs, objects, components, data structures, etc., that perform particular tasks or implement particular abstract data types and may be implemented using hardware at network elements. Non-limiting examples of such hardware may include one or more Central Processing Units (CPUs), digital signal processors (DSPs), application-specific-integrated-circuits, field programmable gate arrays (FPGAs), computers or the like.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

1. Overview

In one aspect of the present disclosure, a device includes memory having computer readable instructions stored therein and one or more processors. The one or more processors are configured to execute the computer-readable instructions to identify participants associated with an event conducted using an online collaboration system; generate a per-participant metric for each one of the participants to generate a plurality of metrics; populate each of the plurality of metrics for a corresponding participant using data received from multiple data sources, each data source providing a particular type of data for the corresponding participant and in association with participation of the corresponding participant in the event; determining a command to be performed on behalf of one or more of the participants; determine, using the plurality of metrics, at least one target associated with the command to yield at least one identified target; and perform the command for the at least one target.

In one aspect of the present disclosure, method includes identifying participants associated with an event conducted using an online collaboration system; generating a per-participant metric for each one of the participants to generate a plurality of metrics; populating each of the plurality of metrics for a corresponding participant using data received from multiple data sources, each data source providing a particular type of data for the corresponding participant and in association with participation of the corresponding participant in the event; determining a command to be performed on behalf of one or more of the participants; determining, using the plurality of metrics, at least one target associated with the command to yield at least one identified target; and performing the command for the at least one target.

In one aspect of the present disclosure, one or more non-transitory computer-readable medium having computer-readable instructions stored therein, which when executed by one or more processors, cause the one or more processors to identify participants associated with an event conducted using an online collaboration system; generate a per-participant metric for each one of the participants to generate a plurality of metrics; populate each of the plurality of metrics for a corresponding participant using data received from multiple data sources, each data source providing a particular type of data for the corresponding participant and in association with participation of the corresponding participant in the event; determining a command to be performed on behalf of one or more of the participants; determine, using the plurality of metrics, at least one target associated with the command to yield at least one identified target; and perform the command for the at least one target.

2. Description

The disclosed technology addresses the need in the art for a system managing an event to implement cognitive actions on behalf of event participants.

Participation and collaboration among participants in an event such as a conference can be organized, tracked and managed using various applications, sensors and devices. From the moment an event is scheduled and invitations are sent out (e.g., via an electronic e-mail system) to acceptance of invitations, pre-event collaborations and document sharing among participants, checking and attending the event including signing-in, collaboration and sharing of documents during the event and post-event actions, relevant data can be collected (hereinafter, “collected data”) and used to further improve user experience and assist participants in carrying out tasks in a seamless way. More specifically and as will be described below, the collected data can be used to carryout cognitive actions on behalf of participants in an event upon receiving corresponding instructions. A system enabling the above can be referred to as a cognitive collaboration system.

While carrying out a cognitive action on behalf of a participant after receiving instructions may be deemed as “reactive,” example embodiments are not limited thereto. For example, the system, as will be described below, can be “proactive” in carrying out cognitive actions or commands on behalf of a participant. For example, upon detecting a presence of an event organizer in a geographical location, the system can proactively start the meeting or ask the organizer whether he or she would like to start the meeting and do so upon receiving a confirmation from the organizer.

The cognitive collaboration system enables the use of natural language to interact with an audio (phone-like) endpoint/sensor to start detecting cognitive actions and performing such actions on behalf of the intended target/user.

The disclosure now turns to the description of an example setting in which an event may take place.

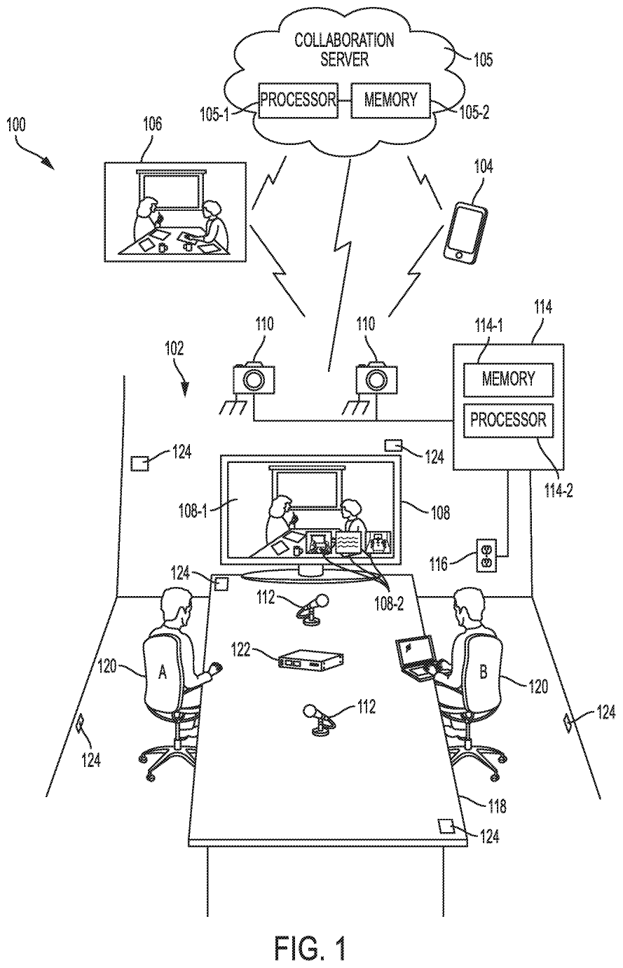

FIG. 1 illustrates an event setting, according to one aspect of the present disclosure. In FIG. 1, an online collaboration session is used an example of an event and a video-enabled conference room is used as an example of an event setting. However, inventive concepts are not limited thereto. Examples of online collaboration session include, but are not limited to, a video conferencing session, an online gaming session, a conference call, whiteboarding and screen sharing among participants in a given geographical locations or in separate remote locations, etc.

In FIG. 1, setting 100 is an online collaboration session using video conferencing. Setting 100 includes three separate parties participating in the online collaboration session. Setting 100 includes a conference room 102, a remote mobile device 104 and another conference room 106. The conference rooms 102 and 106 and the mobile device 104 are remotely connected to one another through the appropriate network and/or Internet connections. In other words, the conference rooms 102 and 106 and the mobile device 104 are located in different geographical locations.

Cloud based component 105 can function as a collaboration server. Collaboration server 105 can have one or more processors such as processor 105-1 and one or more memories such as memory 105-2. Collaboration server 105 can be a private server or a public server providing subscription based services. Setting 100 enables participants in conference rooms 102 and 104 as well as one or more participants associated with mobile device 104 to log into the collaboration server 105 and have the collaboration server 105 manage and run the event.

Furthermore, collaboration server 105 can be used by a participant to setup the online collaboration session (e.g., create an event with a given date and duration as well as identification of participants, etc.). The created event may then be shared with identified participants (invitees) or associated parties via for example, an electronic mail, a text message, an application-based notification, etc. Identified participants can then interact with the invitation to accept, reject or provide any other indication with respect to their participation status in the event.

Conference room 102 includes a display 108, cameras 110, microphones 112, a processing unit 114 and a connection 116 that in one example provides an Ethernet connection to a local area network (LAN) in order for the processing unit 114 to transmit content and/or receive content to and from mobile device 104 and/or conference room 106. The type of connection provided by the connection 116 is not limited to an Ethernet and can be any type of known, or to be developed, wireless and/or wired communication scheme.

Conference room 102 can further include a desk 118 and one or more chairs 120 for participants to use during their presence in conference room 102 (such as participants (speakers) 120-A and 120-B). There can also be a control unit 122 located on table 118, through which various components of a tracking system and video conferencing system can be controlled (e.g., the display 108, cameras 110, microphones 112, etc.). For example, turning the system ON or OFF, adjusting volume of speaker(s) associated with display 108, muting microphones 112, etc., can be controlled via control unit 122.

Conference room 102 can include further data collection devices and sensors 124. Each of sensors 124 can be one of, but is not limited to, an infrared sensor, a temperature sensor, a 3-Dimensional depth sensor, a short-range wireless communication sensor/reader such as a Bluetooth or near-field communication (NFC) reader, a Wi-Fi access point, a motion sensor, a facial recognition sensor including sensors for detecting lip movement for recognizing speech, a speech recognition sensor, an object or human recognition sensor, an image sensor, a voice sensor, a scanner, a proximity sensor, etc. Furthermore, while not shown in FIG. 1, there may be a sensor positioned near an entrance of conference room 102, which may be used to scan entrance and exit of participants by detecting their associated electronic devices (e.g., laptops, smartphones, electronic badges, smart wearable devices, etc.). For example, such sensor located near an entrance may be a badge reader that upon scanning thereof can identify the entrance or exit of a particular participant such as one or more of participants 120.

Control unit 122 and/or any other sensor, microphone, etc., placed therein can be communicatively coupled to collaboration server 105 to relay data collected thereby to collaboration server 105.

Display 108 may be any known or to be developed display device capable of presenting a view of other remote participating parties (e.g., the participant using mobile device 104 and/or participant(s) in conference room 106). As shown in FIG. 1, display 108 has a display section 108-1 and a plurality of thumbnail display sections 108-2. In one example, display section 108-1 displays a view of a current speaker during the video conferencing session. For example, when a participant associated with mobile device 104 speaks, display section 108-1 displays a view of the participating associated with mobile device 104 (which may also include the surrounding areas of the participant visible through a camera of mobile device 104). At the same time, each of thumbnail display sections 108-2 represents a small version of a view of each different remote location and its associated participants taking part in the video conferencing session. For example, assuming that conference room 102 is a branch of company A located in New York and conference room 106 is another branch of company A located in Los Angeles and mobile device 104 is associated with an employee of company A teleworking from Seattle, then one of thumbnail display regions 108-2 corresponds to a view of conference room 102 and its participants as observed by cameras 110, another one of thumbnail display regions 108-2 corresponds to a view of conference room 106 and its participants as observed by cameras installed therein and another one of thumbnail display regions 108-2 corresponds to a view of the teleworking employee of company A using mobile device 104. Furthermore, each thumbnail display region 108-2 can have a small caption identifying a geographical location of each of conference rooms 102 and 106 and mobile device 104 (e.g., New York office, Los Angeles office, Seattle, Wash., etc.).

In one example, thumbnail display images 108-2 may be overlaid on display section 108-1, when display section 108-1 occupies a larger portion of the surface of display device 108 than shown in FIG. 1.

Cameras 110 may include any known or to be developed video capturing devices capable of adjusting corresponding capturing focus, angle, etc., in order to capture a representation of conference room 102 depending on what is happening in conference room 102 at a given point of time. For example, if participant 120-A is currently speaking, one of the cameras 110 can zoom in (and/or tilt horizontally, vertically, diagonally, etc.) in order to present/capture a focused stream of participant 120-A to participants at mobile device 104 and/or conference room 106, a close up version of participant 120-A rather than a view of the entire conference room 102 which results in participant 120-A and/or 120-B being shown relatively smaller (which makes it more difficult for remote participants to determine accurately who the current speaker in conference room 102 is).

Microphones 112 may be strategically positioned around conference room 102 (e.g., on table 118 in FIG. 1) in order to provide for optimal capturing of audio signals from participants present in conference room 102.

In one example, cameras 110 zoom in and out and adjust their capturing angle of content of conference room 102 depending, in part on audio signals received via microphones 112 and according to any known or to be developed method.

Processing unit 114 includes one or more memories such as memory 114-1 and one or more processors such as processor 114-2. In one example, processing unit 114 controls operations of display 108, cameras 110, microphones 112 and control unit 122.

Processing unit 114, display 108, cameras 110, microphones 112 and control unit 122 form one example of a tracking system described above. This tracking system can be the SpeakerTrack system developed, manufactured and distributed by Cisco Technology, Inc., of San Jose, Calif. Tracking system, through control unit 122 can be communicatively coupled to collaboration server 105.

Memory 114-1 can have computer-readable instructions stored therein, which when executed by processor 114-2, transform processor 114-2 into a special purpose processor configured to perform functionalities related to enabling video conferencing and known functionalities of tracking system used in conference room 102. Furthermore, the execution of such computer-readable instructions, transform processor 118-2 into a special purpose processor for creating resolution based content as will be described below.

In one example processing unit 114 may be located at another location and not in conference room 102 (e.g., may be accessible and communicate with components described above via any known or to be developed public and private wireless communication means.

In one example, conference room 106 utilizes a tracking system similar to or exactly the same as tracking system installed in room 102, as described above.

In one example, all sensors and devices described with reference to conference room 102 may be communicatively coupled to collaboration server 105 through any known or to be developed communications scheme.

While certain components and number of different elements are described as being included in setting 100, the present disclosure is not limited thereto. For example, there may be more or less participants participating in a video conferencing session via their corresponding devices than that shown in FIG. 1. There may be more or less participants in each conference room shown in FIG. 1. Mobile device 104 is not limited to being a mobile telephone device but can instead be any known or to be developed mobile computing device having necessary components (e.g., a microphone, a camera, a processor, a memory, a wired/wireless communication means, etc.) for communicating with other remote devices in a video conferencing session.

Furthermore, software/hardware for enabling the video conferencing session may be provided by various vendors such as Cisco Technology, Inc. of San Jose, Calif. Such software program may have to be downloaded on each device or in each conference room prior to being able to participate in an online video conferencing session. By installing such software program, participants can create, schedule, log into, record and complete one or more video conferencing sessions.

According to one or more examples, an online collaboration session may be activated by actions including, but not limited to, a wake word (e.g., “I am here,” “start my meeting,” etc.), detecting presence of one more participants using proximity detection, audio sensors, motion sensors, electronic badge sensors, facial recognition sensors, speech recognition sensors, object sensors, image sensors, etc.

As briefly mentioned above, any one of participants 120, user of mobile device 104 or participants present in conference room 106 may want to carry out a cognitive action during the event. For example, participant 120-A may be an administrator of an event and thus, upon entering conference room 102 may want to carry out the cognitive action of starting the session. However, instead of manually taking steps to start the session, it is more desirable and convenient for participant 120-A to simply speak one or more commands asking collaboration server 105 to start the meeting. If participant 120-A speaks the words “start my meeting,” the collaboration server 105 can determine which participant the term “my” refers to, in order to start the meeting probably. In other words, the collaboration server 105 can determine that the user that uttered the words “start my meeting” is Joe Smith and thus interpret the utterance as “start Joe Smith's meeting”. The collaboration server 105 can therefore determine the identity of the speaker based on data from the various sensors and/or devices as described herein, and process the command based on the determined identity of the user. The command “start my meeting” is an example of a cognitive action.

Another example of a cognitive action is as follows. Assuming that participants 120-A, 120-B, participants present in conference room 106 and the user associated with mobile device 104 are John, Ashley, Steve, John, Amy and Paul, collaboration server 105 needs to distinguish between participants in order to be able to carry out requested cognitive actions on behalf of the appropriate ones of the participants. For example, if Steve speaks the words “send my power point presentation to John,” collaboration server 105 should be able to (1) determine that “my” refers to Steve; (2) retrieve the power point presentation associated with Steve; and (3) determine which “John” is going to be the recipient of the power point presentation.

Another example of a cognitive action is as follows. In the same scenario described above, collaboration server 105 may record the session and have a copy of the recording available for retrieval upon termination of the online collaboration session. Prior to leaving conference room 102, participant 120-A (e.g., Amy) may wish to send the recording of the session to a third party (e.g., her boss, Stephanie) who was not present at the session. Therefore, Amy may provide a command for a cognitive action (e.g., “send recording to Stephanie”). In this case, collaboration server 105 should be able to determine who Stephanie is in order to be able to send the recording to Stephanie.

Another example of a cognitive action is as follows. At any point during or after the online collaboration session, a participant may be interested in retrieving a portion of the session (e.g., a particular segment presented by another participant). For example, Amy may be interested in the presentation given by John. Hence, Amy may provide a corresponding cognitive action command (e.g., “Send me John's presentation”). In this case, collaboration server 105 should be able to (1) determine that “me” refers to Amy; (2) determine which of the two Johns who participated in the session the term “John” refers to; and (3) retrieve the appropriate presentation that was given by John.

The above presents just a few examples of cognitive actions that may be requested by users/participants in an event. Having a system that can automatically parse such commands, determine target(s) and carry out the requested actions on behalf of the requesting participant, will significantly improve the experience of participants of an event and streamlines the administration of the event.

Hereinafter, examples will be described that enable a server such as collaboration server 105 to implement cognitive actions (commands) on behalf of the requesting participant(s).

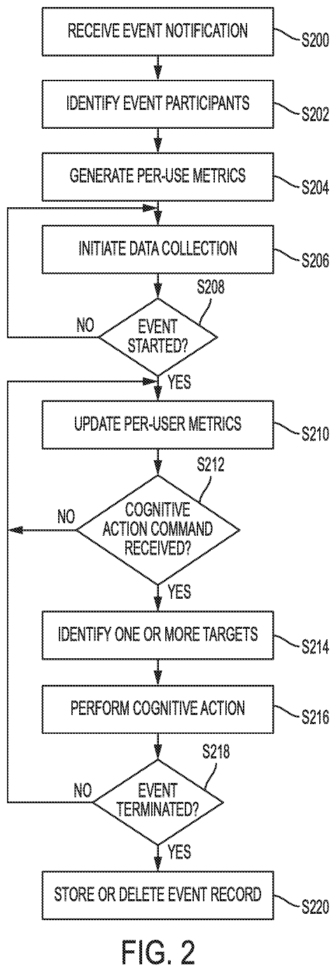

FIG. 2 is a method of automatic implementation of cognitive actions, according to one aspect of the present disclosure. FIG. 2 will be described from the perspective of collaboration server 105. However, it will be understood that collaboration server 105 has one or more processors such as processor 105-1 that can execute one or more computer-readable instructions (software codes) stored on one or more memories such as memory 105-2 to implement functionalities described below.

At S200, collaboration server 105 receives a notification of an event. In one example, collaboration server 105 receives the notification from a service provider through which the event is scheduled. As part of the notification, collaboration server 105 can also receive event information such as the date of the event, timing of the event, identification of invited participants, location of the event, event agenda, event materials, event preferences, event rules, user data (e.g., voice data, image data, etc.), etc.

For example, an example event may be an online collaboration session scheduled using an online/electronic calendar or event scheduling platform/program. Collaboration server 105 may be communicatively coupled to such platform and receive notifications of upcoming events scheduled therethrough. In one example, such platforms may be owned and operated by third party vendors or may be provided and operated by the same entity owning and operating collaboration server 105. In other examples, the event scheduling platform/program can be part of the collaboration server 105.

At S202 and based on event information received at S200, collaboration server 105 identifies participants associated with the event. For example and as described above, John, Ashley, Steve, John, Amy and Paul may be the invited participants participating in the scheduled event.

At S204, collaboration server 105 generates a per-user metric (per-participant metric) for each identified participant.

At S206, collaboration server 105 initiates collection and storing of relevant data in each per-user metric (populating per-user metrics). In one example, in each per-user metric, collaboration server 105 stored various data regarding the corresponding identified participant.

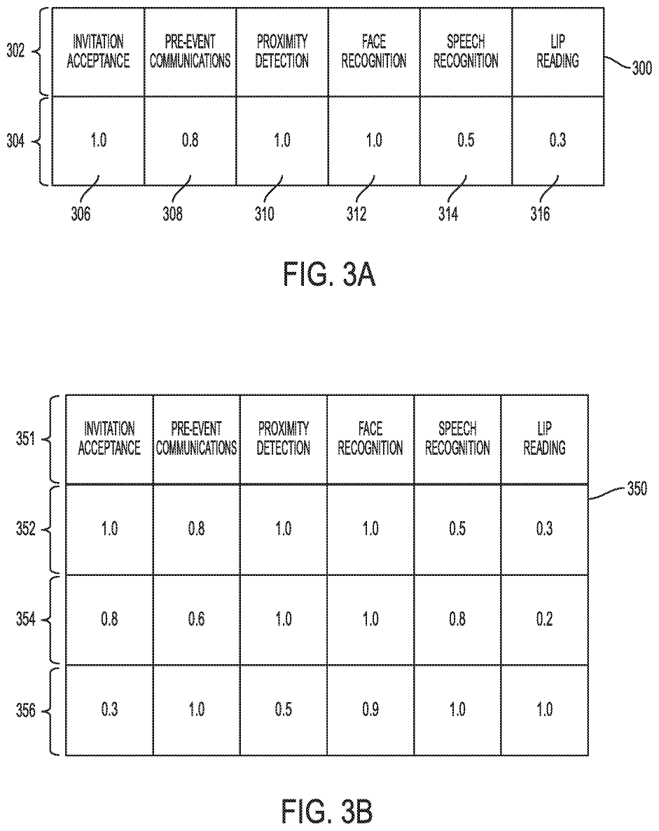

Examples of per-user metrics will be further described below with reference to FIGS. 3A-B.

For example, for Amy as an identified participant, collaboration server 105 generates a per-user metric and initiates collection and storing of data related to Amy and her participation in the event, therein. For example, collaboration server 105 may receive an indication that Amy has accepted the invitation to participate in the event. Collaboration server 105 receives and stores this data in Amy's per-user metric.

Furthermore, prior to initiation of the event, participants may exchange, among themselves or with other individuals, documents and files for the event and/or identify one or more network locations where the collaboration server 105 and/or any participant may access such materials. For example, a power point presentation may be generated by Amy, which is then shared electronically with Steve and approved by another colleague (not an identified participant of the meeting). Parties may exchange two or more versions until a finalized version is created to be presented at the event. The participants may store the materials in a network location accessible by the collaboration server 105. Accordingly, collaborations server 105 may track all such communications and documents associated with Amy and store it in Amy's per-user metric.

Other examples of data tracked and stored in a participant's per-user metric include audio, image and video data recognition outputs, proximity-based recognition data, etc. Therefore, data from multiple sources are gathered, stored and aggregated for target determination, as will be described below. This is advantageous in cases where data from one or more particular sources are insufficient for target detection and therefore data from multiple sources can be used to detect a target, as will be described below.

Data collected by collaboration server 105 can be received from various sensors and data collection devices described with reference to setting 100 of FIG. 1 (e.g., sensors, cameras, microphones, a badge reader, user devices such as smartphones, etc.). These can collectively be referred to as data sources.

Collaboration server 105 can perform the same process for every other identified participant of the event.

At S208, collaboration server 105 detects whether the event has started. This can be for example, based on event information which includes the scheduled date and start time of the event.

If collaboration server 105 determines that the event has not started, the process reverts back to S206, and S206 and S208 are repeated until the event is started.

Upon detecting the start of the event, at S210, collaboration server 105 updates each generated per-user metric with relevant data. Examples of such data includes, but is not limited to, a pre-event (and/or per participant) swipe of a badge to enter conference room 102, a pre-event (and/or per participant) signing into event, proximity detection of participant's associated device within conference room 102 or 106, participant's logging into participant's associated device detected within conference room 102 or 106, etc.

Furthermore, collaboration server 105 can further populate each per-user metric with data corresponding to the respective user's participation in the event including, but not limited to, participant's movement, actions and speaking during the event (e.g., based on data received form one or more sensors 124, microphones 112, location sensors, facial detection using one or more cameras 110, participant's device's camera, etc.).

In one or more examples, there may be one or more additional events with which any one of the identified participants is associated (e.g., another concurrent online collaboration session, an event that terminated before the current event, etc.). The event may be in proximity (time-wise and/or geographical location-wise) of the event of which collaboration server 105 is notified at S200. The per-user metric can also be populated to include this data, which can then be used to determine likelihood of a match target as will be described below.

At S212, collaboration server 105 determines if a command for a cognitive action is received. For example, collaboration server 105 may have speech recognition capabilities that can analyze a received audio and parse the same to determine if a cognitive action is to be performed. Upon performing such speech recognition, collaboration server 105 can search the result for terms such as “my,” “his,” “her,” or names. Collaboration server 105 can also search for verbs that signify an action to be performed. A cognitive command can also be given using written (typed) commands. Examples of cognitive actions can include any of examples provided in this disclosure or any other cognitive action.

In one example, collaboration server 105 may have a cognitive actions database stored on memory 105-2. Such database, which can be updated continuously, can have records of identified cognitive actions over time. Accordingly, upon receiving commands, collaboration server 105 can compare the received command to such database to identify whether a cognitive action command has been received or not.

If collaboration server 105 determines that no command for a cognitive action is received, the process reverts back S210 and continues to perform S210 and S212.

However, upon detection of a cognitive action at S212, collaboration server 105, at S214, determines at least one target associated with the received cognitive action command. Such target can be one or more identified participants of the event or any other target (individual).

In one example, collaboration server 105 identifies the one or more targets based on analyzing per-user metrics using statistical methods including, but not limited to, Baysian (Bayesian) inference to generate a likelihood function and probabilities assigned to each potential target.

For example, upon receiving a command “start my presentation,”, collaboration server 105 applies the Baysian inference to each per-user metric of John, Ashley, Steve, John, Amy and Paul (as identified participants of the event) to determine a likelihood of each identified participants being associated with the term “my” in the received command. Based on the assigned likelihood or probability, collaboration server 105 identified a match for the term “my.”

For example, Amy may have the highest probability of being associated with “my” because at or near the point in time (e.g., a period of 2 minutes) at which the command “start my presentation” is received, video data captured by cameras 110 indicate that Amy has been speaking for a period of time and no other participant has spoken over the same period of time. Therefore, applying the Baysian inference to all per-user metrics returns a high probability for Amy's per-user metric indicating that Amy is highly likely to be the one who provided the command.

In another example, the command may have been “send my presentation to John.” In this case, collaboration server 105 identifies two targets associated with the command. First target would be associated with “my” and the second target would be associated with the term “John.” In other words, collaboration server 105 should determine whose presentation should be sent to which one of the Johns present as participants at the event.

In another example, the command may have been “send my presentation to Patrick” with Patrick (assuming Patrick is a colleague, manager or boss of Amy) not being one of the identified participants in the event. However, collaboration server 105 can determine who Patrick is, because prior to the start of the event, Amy exchanged emails and/or documents with Patrick related to the event and thus corresponding data for Patrick has been collected by collaboration server 105 and stored in Amy's per-user metric.

As described above, Amy (based on the fact that she has been the sole speaker over the given period of time around which the command is received, in the example above) is identified as being associated with “my” in the received command. As for the target associated with the term “John,” collaboration server 105 can apply Baysian inference to each per-metric user associated with one of the Johns and determine a likelihood of a match. For example, collaborations server 105 can determine that one of the Johns just entered conference room 102 (e.g., due to a recent logging in or associated of John with another concurrent or recently terminated event, data for which is included in John's per-user metric) while the other one has been present for the entire duration of Amy's presentation. Therefore, collaboration server 105 can assign a higher likelihood of a match (higher probability) to the John that recently entered conference room 102 for being the intended target to whom Amy's presentation is to be sent.

As briefly mentioned above, steps S212 and S214 may be “reactive.” In other words, implementation of steps S212 and S214 are in response to one or more commands received from a particular event participant. However, inventive concepts are not limited thereto

For example, the start of the event at S208 may be based on a proactive step implemented by collaboration server 105. Upon detecting the presence of Amy in conference room 102 (assuming Amy is the organizer of the event), collaboration server 105 may use the detection to either automatically start the event or prompt Amy whether she wants to start the event or not. Accordingly, collaboration server 105 no longer waits for Amy to provide a command for starting the event but rather, collaboration server 105 proactively starts the event.

In another example, at step S212, instead of receiving an example command from Amy for send her presentation to another participant or another individual not present at the event, collaboration server 105 may proactively provide a command to Amy once it detects Amy has stopped presenting, asking Amy “Who would you like to me to share your presentation with?,” or “Would you like me to send your presentation to Patrick (Amy's boss who may not be present at the event)?” In this example, since the target can be proactively determined by collaboration server 105, either S214 is performed prior to S212 by collaboration server 105 to determine the one or more targets (e.g., to identify Patrick, based on Patrick and/or Amy's per-user metrics) or may be skipped.

Upon identifying one or more targets of a received cognitive action command, at S214, at S216 collaboration server 105 performs the cognitive action (e.g., sends Amy's presentation to John who just entered conference room 102).

Thereafter, at S218, collaboration server 105 determines if the event is terminated. If the event is not terminated, then the process reverts back to S210 and collaboration server 105 repeats S210 to S218. However, if the event is terminated, then at S218, collaboration server 105 either stores a record of the event for future retrieval or deletes the record depending on instructions received from the event organizer.

Having described one of more aspects of the present disclosure for automating implementation of cognitive actions on behalf of event participants, the disclosure now turns to description of system components that can be used to implement collaboration server 105, processing unit 114 and/or control unit 122.

While FIG. 2 and the functions with respect thereto have been described from the perspective of collaboration server 105 that is remotely located relative to conference room 102, inventive concepts are not limited thereto.

In one example, collaboration server 105 may be located in conference room 102. In another example, functionalities of collaboration server 105 described above can be performed by processing unit 114 coupled to various sensors and cameras in conference room 102.

In describing FIG. 2 references have been made to per-user metrics and use thereof in determining targets and carrying out cognitive actions or commands on behalf of participants. FIG. 3A and FIG. 3B illustrate examples of per-user metric(s), according to one example embodiment.

FIG. 3A is an example per-user metric, according to one aspect of the present disclosure. FIG. 3A shows an example of a one dimensional per-user metric for a given participant in the event (e.g., John, Amy, etc.). The per-user metric 300 may have a label row 302 and a value row 304. The value row 304 may have several entries 306-316. The number of entries may be more or less than that shown in FIG. 3A.

Each one of entries 306-3016 may have a weighted value stored therein (e.g., between 0 and 1), with 1 representing the highest likelihood (certainty) that a corresponding action/detection has taken place and 0 representing the lowest likelihood of the same. As an example, entry 306 may correspond to collaboration server 105's detection of whether Amy has accepted an invite for an event. If Amy has accepted, entry 306 will be populated with value 1. If not, the value would be 0.

Entry 308 may correspond to Amy's pre-event communications regarding the event (e.g., exchange of documents with her boss, Patrick). An example weighted value 0.8 is provided for entry 304 indicating that Amy has exchanged documents with Patrick (e.g., two revisions of a power point presentation to be presented by Amy at the event).

Entries 310 through 316 may correspond to proximity detection of Amy in conference room 102, results of face recognition for Amy, results of speech recognition for Amy and lip reading recognition for Amy, respectively.

In one example, the table 300 may be multi-dimensional. In one example, the weighted value of each one of entries 306-316 may be dynamically changed throughout the event. For example, while initially, Amy's proximity detection value is set to 1, such proximity detection may change throughout the event due to Amy's movement around conference room 102, due to Amy leaving conference room 102 temporarily, etc. For example, if proximity sensors such as sensors 124 are unable to detect Amy's device for a period of time, the corresponding value in entry 306 may be changed from 1 to 0.

In one example, a value of each entry at any given point in time may be an average of values determined over a time interval (e.g., 10 seconds, 30 seconds, 1 minute, etc.), where the duration of the time interval may be a configurable parameter determined based on experiments and/or empirical studies.

FIG. 3B is an example collection of per-user metrics, according to one aspect of the present disclosure. FIG. 3B illustrates a collection of per-user metrics for multiple participants in an event. Table 350 includes a label row 351 similar to label row 302 of FIG. 3A as well as an example collection of per-user metrics 352, 354 and 356 for three different participants (e.g., Amy, John and Steve), with each per-user metric 352, 354 and 356 including values for similar entries as entries 302-312 described above with reference to FIG. 3A. In the example of FIG. 3B, per-user metric 352 corresponds to per-user metric 300 of FIG. 3A.

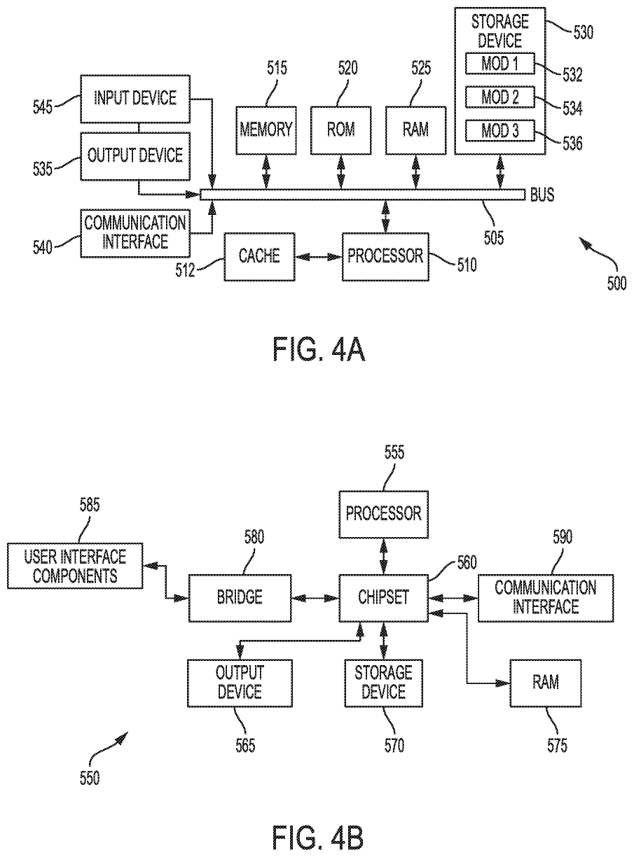

FIG. 4A is an example system, according to one aspect of the present disclosure. FIG. 4B is an example system, according to one aspect of the present disclosure. The more appropriate example embodiment will be apparent to those of ordinary skill in the art when practicing the present technology. Persons of ordinary skill in the art will also readily appreciate that other system embodiments are possible. In some embodiments, the conference room device, the screen assistive device, the server, or the client device may be implemented using a system illustrated in FIG. 4A or FIG. 4B or variations of one of the systems.

FIG. 4A shows a conventional system bus computing system architecture 500 wherein the components of the system are in electrical communication with each other using a bus 505. Example system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 4B shows a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that example systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A device comprising:
memory having computer readable instructions stored therein; and
one or more processors configured to execute the computer-readable instructions to:
identify participants associated with an event conducted using an online collaboration system;
generate a per-participant metric for each one of the participants to generate a plurality of metrics;
populate each of the plurality of metrics for a corresponding participant using data received from multiple data sources, each data source providing a particular type of data for the corresponding participant and in association with participation of the corresponding participant in the event;
determining a command to be performed on behalf of one or more of the participants;
determine, using the plurality of metrics, at least one target associated with the command to yield at least one identified target; and
perform the command for the at least one target.

2. The device of claim 1, wherein the one or more processors are configured to execute the computer-readable instructions to:
receive information corresponding to at least one additional event taking place within a proximity of the event; and
determine the at least one identified target based on the plurality of metrics and data associated with the at least one additional event.

3. The device of claim 1, wherein the one or more processors are configured to execute the computer-readable instructions to determine the at least one identified target by:
identifying at least two targets associated with the command;
assigning a probability value to each per-participant metric associated with one of the at least two targets; and
determining the at least one identified target based on the probability value assigned to each per-participant metric associated with one of the at least two targets.

4. The device of claim 1, wherein the plurality of data sources include one or more of a video camera, an audio sensor, a 3-dimensional depth sensor, a temperature sensor, system login information of the participants, a short-range wireless communication device and an electronic badge reader.

5. The device of claim 1, wherein the at least one target is not one of the participants associated with the event.

6. The device of claim 1, wherein the command is a task to be performed in association with one or more of conducting the event, storing a record in association with the event or sharing content of the event.

7. The device of claim 1, wherein the at least one identified target is one or more of one of the participants or an intended audience of the command.

8. The device of claim 1, wherein the device is a server communicatively coupled to the multiple data sources associated with the event.

9. A method comprising:
identifying participants associated with an event conducted using an online collaboration system;
generating a per-participant metric for each one of the participants to generate a plurality of metrics;
populating each of the plurality of metrics for a corresponding participant using data received from multiple data sources, each data source providing a particular type of data for the corresponding participant and in association with participation of the corresponding participant in the event;
determining a command to be performed on behalf of one or more of the participants;
determining, using the plurality of metrics, at least one target associated with the command to yield at least one identified target; and
performing the command for the at least one target.

10. The method of claim 9, further comprising:
receiving information corresponding to at least one additional event taking place within a proximity of the event; and
determining the at least one identified target based on the plurality of metrics and data associated with the at least one additional event.

11. The method of claim 9, wherein determining the at least one identified target comprises:
identifying at least two targets associated with the command;
assigning a probability value to each per-participant metric associated with one of the at least two targets; and
determining the at least one identified target based on the probability value assigned to each per-participant metric associated with one of the at least two targets.

12. The method of claim 9, wherein the plurality of data sources include one or more of a video camera, an audio sensor, a 3-dimensional depth sensor, a temperature sensor, system login information of the participants, a short-range wireless communication device and an electronic badge reader.

13. The method of claim 9, wherein the command is a task to be performed in association with one or more of conducting the event, storing a record in association with the event or sharing content of the event.

14. The method of claim 9, wherein the at least one identified target is one or more of one of the participants or an intended audience of the command.

15. The method of claim 9, wherein populating each of the plurality of metrics includes:
storing data of the corresponding participant prior to start of the event; and
updating the data using information collected for the corresponding participant during the event.

16. One or more non-transitory computer-readable medium having computer-readable instructions stored therein, which when executed by one or more processors, cause the one or more processors to:
identify participants associated with an event conducted using an online collaboration system;
generate a per-participant metric for each one of the participants to generate a plurality of metrics;
populate each of the plurality of metrics for a corresponding participant using data received from multiple data sources, each data source providing a particular type of data for the corresponding participant and in association with participation of the corresponding participant in the event;
determining a command to be performed on behalf of one or more of the participants;
determine, using the plurality of metrics, at least one target associated with the command to yield at least one identified target; and
perform the command for the at least one target.

17. The one or more non-transitory computer-readable medium of claim 16, wherein execution of the computer-readable instructions by the one or more processors cause the one or more processors to:
receive information corresponding to at least one additional event taking place within a proximity of the event; and
determine the at least one identified target based on the plurality of metrics and data associated with the at least one additional event.

18. The one or more non-transitory computer-readable medium of claim 16, wherein execution of the computer-readable instructions by the one or more processors cause the one or more processors to:
identify at least two targets associated with the command;
assign a probability value to each per-participant metric associated with one of the at least two targets; and
determine the at least one identified target based on the probability value assigned to each per-participant metric associated with one of the at least two targets.

19. The one or more non-transitory computer-readable medium of claim 16, wherein the command is a task to be performed in association with one or more of conducting the event, storing a record in association with the event or sharing content of the event.

20. The one or more non-transitory computer-readable medium of claim 16, wherein execution of the computer-readable instructions by the one or more processors cause the one or more processors to populate each of the plurality of metrics by:
storing data of the corresponding participant prior to start of the event; and
updating the data using information collected for the corresponding participant during the event.
